(19) United States
(12) Patent Application Publication
(10) Pub. No.: US 2025/0328172 A1
(43) Pub. Date: Oct. 23, 2025

(54) HANDHELD BLUETOOTH PHOTOGRAPHING SCREEN

(71) Applicant: Qili Yuan, Shenzhen (CN)

(72) Inventor: Qili Yuan, Shenzhen (CN)

(21) Appl. No.: 18/963,867

(22) Filed: Nov. 29, 2024

(30) Foreign Application Priority Data
Apr. 22, 2024 (CN) 202410486641.6
May 9, 2024 (CN) 202420988373.3
May 24, 2024 (CN) 202421154416.4

(51) Int. Cl. G06F 1/16; G02F 1/1333; G06F 3/14

(52) U.S. Cl. CPC G06F 1/1698; G02F 1/13338; G06F 3/14

(57) ABSTRACT

A handheld Bluetooth photographing screen includes a main body. The main body is equipped with a display screen and a control circuit board electrically connected to the display screen. The handheld Bluetooth photographing screen further includes a Bluetooth module and a WiFi module both electrically connected to the control circuit board. Therefore, the handheld Bluetooth photographing screen can communicate with a terminal device such as a mobile phone through the Bluetooth module. The Bluetooth module, after receiving the photography control signal from the control circuit board, transmits the photography control signal to the mobile phone and controls a photography function of the mobile phone to achieve a purpose of photography. The WiFi module receives a display signal from the mobile phone and transmits the display signal to the control circuit board, and then the display screen can achieve simultaneous display with the mobile phone, achieving real-time viewing of photography effects.

### CROSS-REFERENCE TO RELATED APPLICATIONS

The application claims priority of Chinese patent application CN2024104866416, filed on Apr. 22, 2024, which is incorporated herein by reference in its entireties. The application also claims priority of Chinese patent application CN2024209883733, filed on May 9, 2024, which is incorporated herein by reference in its entireties. The application also claims priority of Chinese patent application CN2024211544164, filed on May 24, 2024, which is incorporated herein by reference in its entireties.

### TECHNICAL FIELD

The present invention relates to the technical field of wireless photographing devices, particularly to a handheld Bluetooth photographing screen.

### BACKGROUND ART

With the continuous advancement of technology in recent years, the development of smartphones has also fully incorporated technologies such as artificial intelligence and 5G, making smartphones the most widely used patented products. When people use smartphones to take photos, they generally need to take group photos from a distance. Although there are now selfie sticks to achieve this effect, the length of a selfie stick is generally within 2 meters. When many people take photos together, only the upper body can be captured and full body photos cannot be taken as a souvenir. It is also not suitable for many people to take photos together. Similarly, with the continuous improvement of pixels of mobile phones' cameras, more and more people choose to use mobile phones to take photos, especially some travel enthusiasts who choose to carry mobile phones instead of professional cameras for portability. However, for the consideration of cost, the pixels of the front camera of a mobile phone are usually much lower than those of the rear camera. In order to take clear photos, people usually choose to ask nearby people to help take photos, but the photos usually do not come out well enough to meet the requirements of the person being photographed. Moreover, in many cases, there is no one around the person being photographed to help take photos. When a delayed shooting function of mobile phones is used for taking photos, since the person being photographed cannot see the lens, it is more difficult to take a photo that satisfies the person being photographed. Although a front camera with high pixels and a selfie stick together can solve the above problems, the cost of the mobile phone is high. For communication tools like mobile phones that are updated and replaced quickly, it is a waste. Moreover, limited by the length of the selfie stick and human vision, the person being photographed cannot be too far away from the screen of the mobile phone, which limits the area captured by the camera of the mobile phone. When there are many people taking a group photo, not all people can be displayed in one photo.

### SUMMARY

In order to overcome the shortcomings of the prior art, a handheld Bluetooth photographing screen is provided in the present invention, which solves the problem that a rear camera of a current mobile phone has a good photographing effect but a screen can not be seen, greatly improving the convenience of selfie.

The technical solution adopted by the present invention to solve its technical problem is as follows.

A handheld Bluetooth photographing screen includes a main body and further includes:
a control circuit board positioned inside the main body;
a display screen positioned on a front surface of the main body, wherein the display screen is electrically connected to the control circuit board;
a Bluetooth module electrically connected to the control circuit board, wherein the Bluetooth module is used for connecting with an external mobile terminal for communication, the Bluetooth module is used for receiving a photography control signal from the control circuit board, transmitting the photography control signal to the external mobile terminal, and controlling a photography action of the mobile terminal;
a WiFi module electrically connected to the control circuit board, wherein the WiFi module is used for connecting with the external mobile terminal for communication, and the WiFi module is used for receiving a display signal from the external mobile terminal and transmitting the signal to the control circuit board for displaying on the display screen simultaneously; and
a power component positioned inside the main body, wherein the power component is electrically connected to the display screen and the control circuit board.

As an improvement of the present invention, the WiFi module is also used for receiving a touch command from the control circuit board, sending the touch command to the external mobile terminal, and controlling operation of the external mobile terminal.

As an improvement of the present invention, an outer side wall of the main body is also equipped with a control button, and the control button is electrically connected to the control circuit board.

As an improvement of the present invention, the control button includes a Bluetooth photographing button for photography control and a power button.

As an improvement of the present invention, the power button includes a first function mode and a second function mode. The Bluetooth photographing button includes a first button mode and a second button mode. When the power button is pressed once, the power button is in the first function mode, and the Bluetooth photographing button is in the first button mode. When the power button is pressed twice, the power button is in the second function mode, and the Bluetooth photographing button is in the second button mode.

As an improvement of the present invention, the first function mode is a power-on/off mode, and the second function mode is a focusing mode. The first button mode is a shooting mode, and the second button mode is a focus segment switching mode.

As an improvement of the present invention, the main body includes a main body shell and an inner frame. The inner frame is positioned in an inner layer of the main body shell and matches the main body shell. The display screen is mounted on the inner frame, and the control circuit board and the power component are positioned on an opposite surface of the inner frame from the display screen.

As an improvement of the present invention, the display screen includes an integrated screen of touch display embedded in the inner frame and a transparent protective cover plate positioned on an upper side of the integrated screen of touch display.

As an improvement of the present invention, the display screen includes a liquid crystal display screen embedded in the inner frame, a touch screen positioned on an upper side of the liquid crystal display screen, and a transparent protective cover plate positioned on an upper side of the touch screen.

As an improvement of the present invention, an embedding slot matching the liquid crystal display screen is defined in the inner frame. The handheld Bluetooth photographing screen further includes a connecting through hole defined in the inner frame, and the liquid crystal display screen is electrically connected to the control circuit board through the connecting through hole.

As an improvement of the present invention, a magnetic attraction block is provided on a back surface of the main body shell, and the main body is attached to a back surface of the external mobile terminal through the magnetic attraction block.

As an improvement of the present invention, the back surface of the main body shell is also provided with a bracket connecting hole for connecting with a support bracket. The bracket connecting hole is a spherical connecting hole or a rotating shaft type connection hole.

As an improvement of the present invention, an inner portion of the main body is also provided with a sound emitting device for synchronously emitting sound when a video is played. The sound emitting device is electrically connected to the control circuit board, and a sound emitting hole is defined in a lower portion or a side wall of the main body shell.

As an improvement of the present invention, the main body is provided with a microphone component, and the microphone component is electrically connected to the control circuit board. Microphone holes are defined at a lower portion of the main body shell.

As an improvement of the present invention, the main body is also provided with an SD card slot, and a side edge of the main body is provided with an HDMI interface.

As an improvement of the present invention, a back surface of the main body is also equipped with a dust cover to prevent dust from entering an inner portion of the main body.

As an improvement of the present invention, a model of the WiFi module is RTL8188FTV.

As an improvement of the present invention, the inner frame is connected to the main body shell through a screw. A plurality of screw columns for connection are integrally formed on an inner side of the main body shell. An outer periphery of the inner frame is provided with through holes corresponding to the screw columns.

As an improvement of the present invention, a model of a control chip in the control circuit board is DH350D.

As an improvement of the present invention, steps for the Bluetooth module to make a Bluetooth connection and take a photo are: S1, turning on Bluetooth of the external mobile terminal; S2, searching for and connecting to the handheld Bluetooth photographing screen with the external mobile terminal; S3, pressing the power button once to activate the handheld Bluetooth photographing screen; and S4, after the handheld Bluetooth photographing screen being activated, pressing the Bluetooth photographing button to take a photo.

Connection steps for the WiFi module to perform simultaneous display are as follows: S1, turning on a WiFi function of the external mobile terminal and searching for a name of the handheld Bluetooth photographing screen; S2, entering a password for connection; S3, turning on a screen projection function of the external mobile terminal and searching for the name of the handheld Bluetooth photographing screen; and S4, performing screen projection display after connection.

As an improvement of the present invention, steps for focusing the handheld Bluetooth photographing screen are as follows: S1, after the handheld Bluetooth photographing screen being activated, pressing the power button twice to activate the focusing mode; and S2, after the focusing mode being activated, pressing an upper end or a lower end of the Bluetooth photographing button to switch and adjust the focus segment.

As an improvement of the present invention, a model of the Bluetooth module is nRF52840. A model of the WiFi module is SYN480R. A model of the control chip in the control circuit board is Snapdragon870.

Beneficial effects of the present invention are as follows. The handheld Bluetooth photographing screen is provided in the present invention, including the main body. The main body is equipped with the display screen and the control circuit board electrically connected to the display screen. The handheld Bluetooth photographing screen further includes the Bluetooth module and the WiFi module both electrically connected to the control circuit board. Therefore, the handheld Bluetooth photographing screen can communicate with the terminal device such as a mobile phone through the Bluetooth module. The Bluetooth module, after receiving the photography control signal from the control circuit board, transmits the photography control signal to the mobile phone and controls a photography function of the mobile phone to achieve a purpose of photography. The WiFi module receives a display signal from the mobile phone and transmits the display signal to the control circuit board, and then the display screen can achieve simultaneous display with the mobile phone, achieving real-time viewing of photography effects. Compared with existing camera devices, the present invention solves the problem that the rear camera of the current mobile phone has a good shooting effect, but a user cannot see a screen, greatly improving the convenience of selfies and solving the problem of difficulty in taking selfies with the rear camera of the mobile phone.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic diagram of an overall structure of the present invention.

FIG. 2 is an exploded view of the present invention.

FIG. 3 is an exploded view of another embodiment of the present invention.

FIG. 4 is a schematic diagram of an overall structure of the present invention from another angle of view.

FIG. 5 is a principle block diagram of the present invention.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

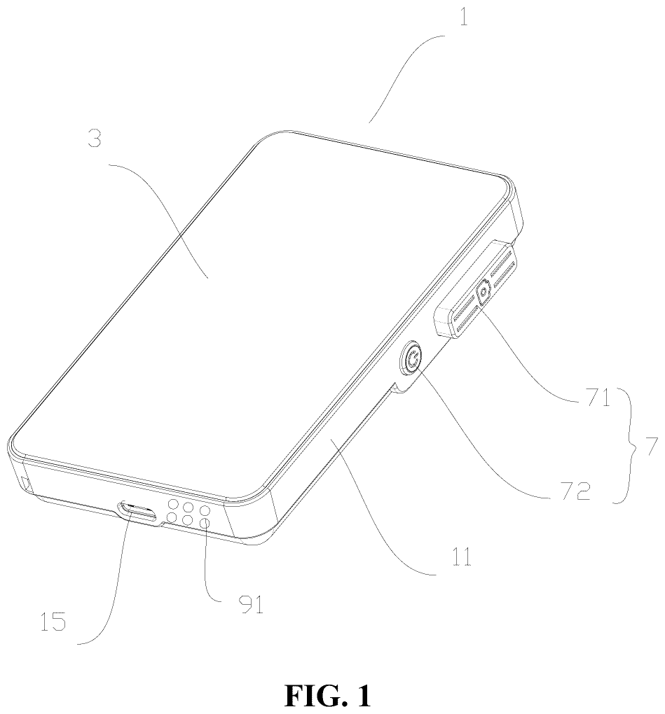

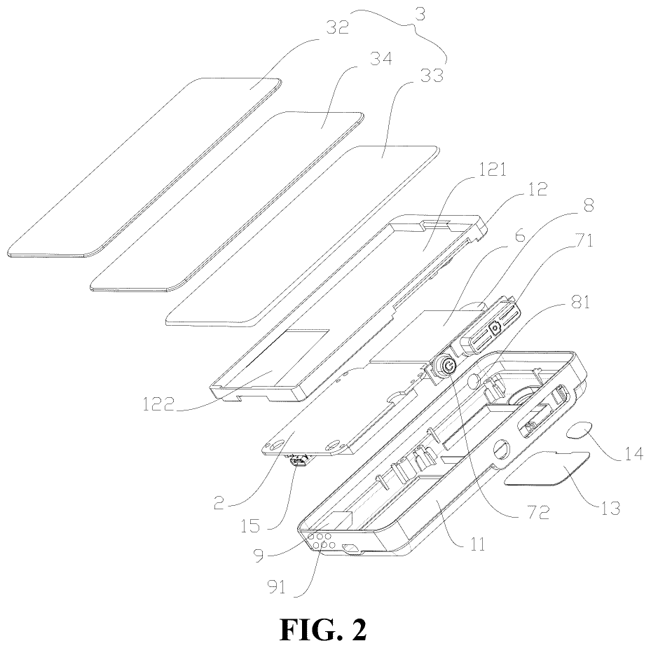

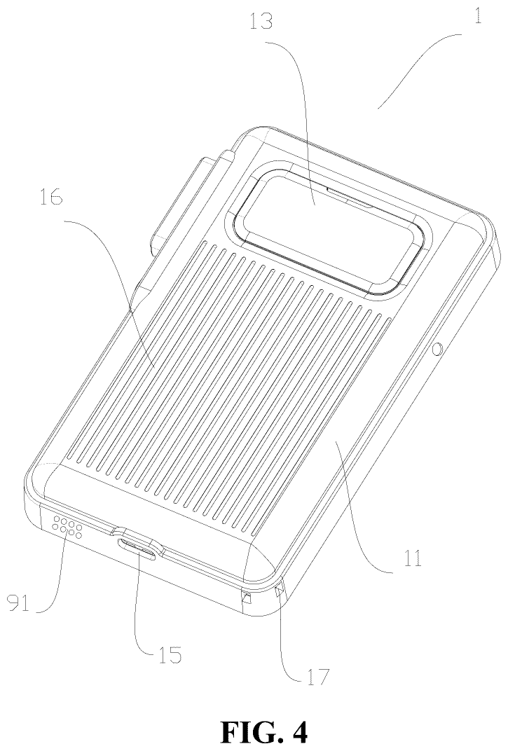

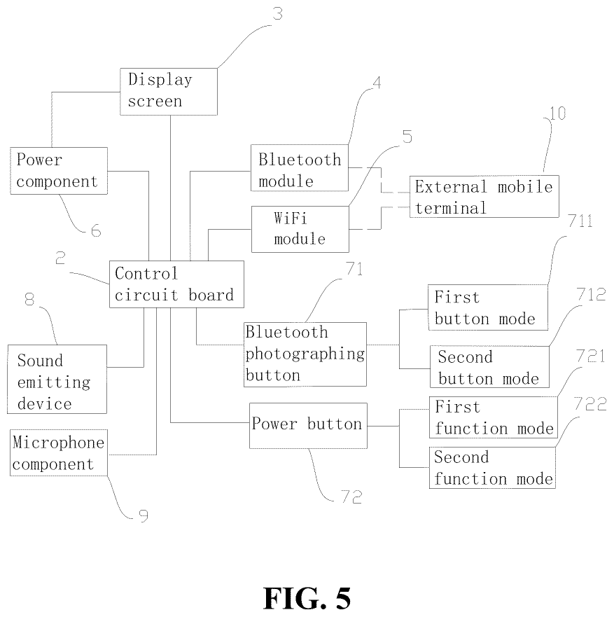

Referring to FIGS. 1-5, a handheld Bluetooth photographing screen includes a main body 1 and further includes:
a control circuit board 2 positioned inside the main body 1;
a display screen 3 positioned on a front surface of the main body 1, wherein the display screen 3 is electrically connected to the control circuit board 2;
a Bluetooth module 4 electrically connected to the control circuit board 2, wherein the Bluetooth module 4 is used for connecting with an external mobile terminal 10 for communication, the Bluetooth module 4 is used for receiving a photography control signal from the control circuit board 2, transmitting the photography control signal to the external mobile terminal 10, and controlling a photography action of the mobile terminal;
a WiFi module 5 electrically connected to the control circuit board 2, wherein the WiFi module 5 is used for connecting with the external mobile terminal 10 for communication, and the WiFi module 5 is used for receiving a display signal from the external mobile terminal 10 and transmitting the signal to the control circuit board 2 for displaying on the display screen 3 simultaneously; and
a power component 6 positioned inside the main body 1, wherein the power component 6 is electrically connected to the display screen 3 and the control circuit board 2.

Through the above structure, the handheld Bluetooth photographing screen includes the main body 1. The main body 1 is equipped with the display screen 3 and the control circuit board 2 electrically connected to the display screen 3. The handheld Bluetooth photographing screen is also equipped with the Bluetooth module 4 and the WiFi module 5 both electrically connected to the control circuit board 2. Therefore, the handheld Bluetooth photographing screen can communicate with a terminal device such as a mobile phone through the Bluetooth module 4. The Bluetooth module 4, after receiving the photography control signal from the control circuit board 2, transmits the photography control signal to the mobile phone and controls a photography function of the mobile phone to achieve a purpose of photography. Moreover, the WiFi module 5 receives a display signal from the mobile phone and transmits the display signal to the control circuit board 2, and then the display screen 3 can achieve simultaneous display with the mobile phone, achieving a function of real-time viewing of photography effects. Compared with existing camera devices, the present invention solves the problem that a rear camera of a current mobile phone has a good shooting effect, but a user cannot see a screen, greatly improving the convenience of selfies and solving the problem of difficulty in taking selfies with the rear camera of the mobile phone.

In this embodiment, the WiFi module 5 is also used for receiving a touch command from the control circuit board 2, sending the touch command to the external mobile terminal 10, and controlling operation of the external mobile terminal 10. Through the above structure, since the WiFi module 5 is also used for receiving the touch command from the control circuit board 2, after transmitting the touch command to the mobile phone, the WiFi module 5 can control the operation of the mobile phone, enhancing the versatility and practicality of the photographing screen.

In this embodiment, an outer side wall of the main body 1 is also equipped with a control button 7, and the control button 7 is electrically connected to the control circuit board 2. Specifically, the control button 7 includes a Bluetooth photographing button 71 for photography control and a power button 72. In some other embodiments, the control button 7 may also include a dedicated focusing button. Through the focusing button, a focusing mode can be activated and a focus segment can be switched.

Furthermore, the power button 72 includes a first function mode 721 and a second function mode 722. The Bluetooth photographing button 71 includes a first button mode 711 and a second button mode 712. When the power button 72 is pressed once, the power button 72 is in the first function mode 721, and the Bluetooth photographing button 71 is in the first button mode 711. When the power button 72 is pressed twice, the power button 72 is in the second function mode 722, and the Bluetooth photographing button 71 is in the second button mode 712.

Furthermore, the first function mode 721 is a power-on/off mode, and the second function mode 722 is a focusing mode. The first button mode 711 is a shooting mode, and the second button mode 712 is a focus segment switching mode.

Through the above structure, since the power button 72 has two function modes, different function modes can be switched by pressing for different number of times. When the power button 72 is pressed once, the handheld photographing screen can be turned on or off. After turning on, the Bluetooth photographing button 71 is in the shooting mode, and the Bluetooth photographing button 71 can be pressed to perform a shooting function. When the power button 72 is pressed twice in a short period of time, the power button 72 is switched to the focusing mode, that is, the mobile phone will be controlled to turn on a shooting focusing function. At this time, by pressing an upper end or a lower end of the Bluetooth photographing button 71, the focus segment can be switched. The Bluetooth photographing button 71 here includes two contacts, namely the upper end and the lower end, effectively realizing the shooting focusing function of the handheld Bluetooth photographing screen. The multi-mode of the above buttons greatly increases the practicality and portability of the handheld Bluetooth photographing screen.

In this embodiment, the main body 1 includes a main body shell 11 and an inner frame 12. The inner frame 12 is positioned in an inner layer of the main body shell 11 and matches the main body shell 11. The display screen 3 is mounted on the inner frame 12, and the control circuit board 2 and the power component 6 are positioned on an opposite surface of the inner frame 12 from the display screen 3.

In this embodiment, the display screen 3 includes a liquid crystal display screen 33 embedded in the inner frame 12, a touch screen 34 positioned on an upper side of the liquid crystal display screen 33, and a transparent protective cover plate 32 positioned on an upper side of the touch screen. Furthermore, an embedding slot 121 matching the liquid crystal display screen 33 is defined in the inner frame 12. The handheld Bluetooth photographing screen further includes a connecting through hole 122 defined in the inner frame 12, and the liquid crystal display screen 33 is electrically connected to the control circuit board 2 through the connecting through hole 122. The liquid crystal display screen 33 is an LCD screen body. Through the above structure, the design is simple and clever, ensuring the stability of the screen and the main body shell 11.

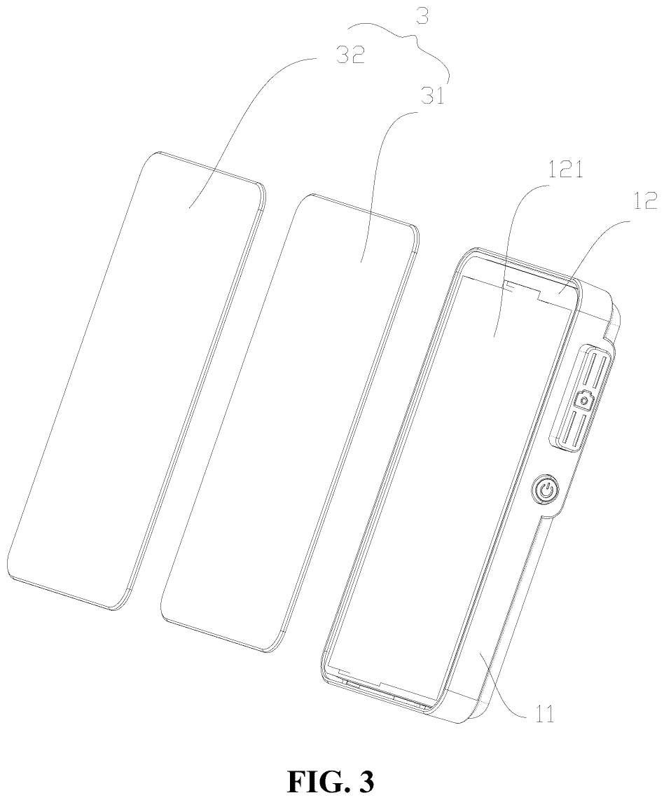

As shown in FIG. 3, in another embodiment, the display screen 3 includes an integrated screen of touch display 31 embedded in the inner frame 12 and a transparent protective cover plate 32 positioned on an upper side of the integrated screen of touch display 31.

In this embodiment, a magnetic attraction block 13 is provided on a back surface of the main body shell 11, and the main body 1 is attached to a back surface of the external mobile terminal 10 through the magnetic attraction block 13. Through the above structure, due to the arrangement of the magnetic attraction block 13, the handheld Bluetooth photographing screen can be attached to the mobile phone at any time, making it convenient for the user to carry.

In other embodiments, the back surface of the main body shell 11 is also provided with a bracket connecting hole for connecting with a support bracket. The bracket connecting hole is a spherical connecting hole or a rotating shaft type connection hole. Through the above structure, it is convenient for the user to fix the photographing screen on the bracket, providing a more effortless photography experience.

In other embodiments, the main body 1 further includes an angle adjustment button for flexibly controlling a shooting angle of the external mobile terminal 10. For example, by fixing the external mobile terminal 10 on a smartphone support bracket, the angle adjustment button mentioned above can be used to drive an angle adjustment action of the smartphone support bracket through signal transmission, and the user does not need to approach the mobile terminal for operation, thereby greatly improving convenience.

In this embodiment, an inner portion of the main body 1 is also provided with a sound emitting device 8 for synchronously emitting sound when a video is played. The sound emitting device 8 is electrically connected to the control circuit board 2, and a sound emitting hole 81 is defined in a lower portion or a side wall of the main body shell 11. Through the above structure, when shooting videos, the sound emitting device 8 can simultaneously play sound synchronized with the phone, which better improves the shooting effect.

In this embodiment, a microphone component 9 is provided at a bottom side portion of the main body 1, and the microphone component 9 is electrically connected to the control circuit board 2. Microphone holes 91 are defined at a lower portion of the main body shell 11. Through the above structure, when the user shoot videos, the microphone assembly 9 can be used for sound reception, increasing the versatility of shooting.

In other embodiments, the main body 1 is provided with an SD card slot, and a side edge of the main body 1 is provided with an HDMI interface.

In this embodiment, a back surface of the main body 1 is also equipped with a dust cover 14 to prevent dust from entering an inner portion of the main body 1. Through the above structure, the dust cover 14 plays a role in protecting the main body 1. In actual use, the user may go to environments with high dust to take photos. The design of the dust cover 14 extends the service life of the handheld Bluetooth photographing screen.

In this embodiment, in order to improve the grip stability of the product, an anti-slip texture 16 can also be provided on the back surface of the main body shell 11.

In this embodiment, a model of the WiFi module 5 is RTL8188FTV.

In this embodiment, a model of a control chip in the control circuit board 2 is DH350D.

In this embodiment, steps for the Bluetooth module 4 to make a Bluetooth connection and take a photo are: S1, turning on Bluetooth of the external mobile terminal 10; S2, searching for and connecting to the handheld Bluetooth photographing screen with the external mobile terminal 10; S3, pressing the power button 72 once to activate the handheld Bluetooth photographing screen; and S4, after the handheld Bluetooth photographing screen being activated, pressing the Bluetooth photographing button 71 to take a photo.

Connection steps for the WiFi module 5 to perform simultaneous display are as follows: S1, turning on a WiFi function of the external mobile terminal 10 and searching for a name of the handheld Bluetooth photographing screen; S2, entering a password for connection; S3, turning on a screen projection function of the external mobile terminal 10 and searching for the name of the handheld Bluetooth photographing screen; and S4, performing screen projection display after connection.

In this embodiment, steps for focusing the handheld Bluetooth photographing screen are as follows: S1, after the handheld Bluetooth photographing screen being activated, pressing the power button 72 twice to activate the focusing mode; and S2, after the focusing mode being activated, pressing the upper end or the lower end of the Bluetooth photographing button 71 to switch and adjust the focus segment.

In another embodiment, a model of the Bluetooth module 4 is nRF52840. A model of the WiFi module 5 is SYN480R. A model of the control chip in the control circuit board 2 is Snapdragon870.

In this embodiment, the main body is equipped with a charging plug interface 15. The charging plug interface 15 is a Type-C interface, which facilitates charging with an existing charging plug.

In this embodiment, the main body is also provided with a hanging hole 17, so that a hanging rope of a decorative pendant can be hung on the handheld Bluetooth photographing screen through the hanging hole 17.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

What is claimed is:

1. A handheld Bluetooth photographing screen, comprising a main body, and further comprising:
a control circuit board positioned inside the main body;
a display screen positioned on a front surface of the main body, wherein the display screen is electrically connected to the control circuit board;
a Bluetooth module electrically connected to the control circuit board, wherein the Bluetooth module is used for connecting with an external mobile terminal for communication, the Bluetooth module is used for receiving a photography control signal from the control circuit board, transmitting the photography control signal to the external mobile terminal, and controlling a photography action of the mobile terminal;
a WiFi module electrically connected to the control circuit board, wherein the WiFi module is used for connecting with the external mobile terminal for communication, and the WiFi module is used for receiving a display signal from the external mobile terminal and transmitting the signal to the control circuit board for displaying on the display screen simultaneously; and
a power component positioned inside the main body, wherein the power component is electrically connected to the display screen and the control circuit board.

2. The handheld Bluetooth photographing screen according to claim 1, wherein the WiFi module is also used for receiving a touch command from the control circuit board, sending the touch command to the external mobile terminal, and controlling operation of the external mobile terminal.

3. The handheld Bluetooth photographing screen according to claim 1, wherein an outer side wall of the main body is also equipped with a control button, and the control button is electrically connected to the control circuit board.

4. The handheld Bluetooth photographing screen according to claim 3, wherein the control button comprises a Bluetooth photographing button for photography control and a power button.

5. The handheld Bluetooth photographing screen according to claim 4, wherein the power button comprises a first function mode and a second function mode, and the Bluetooth photographing button comprises a first button mode and a second button mode; when the power button is pressed once, the power button is in the first function mode, and the Bluetooth photographing button is in the first button mode; when the power button is pressed twice, the power button is in the second function mode, and the Bluetooth photographing button is in the second button mode.

6. The handheld Bluetooth photographing screen according to claim 5, wherein the first function mode is a power-on/off mode, and the second function mode is a focusing mode; the first button mode is a shooting mode, and the second button mode is a focus segment switching mode.

7. The handheld Bluetooth photographing screen according to claim 1, wherein the main body comprises a main body shell and an inner frame, the inner frame is positioned in an inner layer of the main body shell and matches the main body shell, the display screen is mounted on the inner frame, and the control circuit board and the power component are positioned on an opposite surface of the inner frame from the display screen.

8. The handheld Bluetooth photographing screen according to claim 7, wherein the display screen comprises an integrated screen of touch display embedded in the inner frame and a transparent protective cover plate positioned on an upper side of the integrated screen of touch display.

9. The handheld Bluetooth photographing screen according to claim 7, wherein the display screen comprises a liquid crystal display screen embedded in the inner frame, a touch screen positioned on an upper side of the liquid crystal display screen, and a transparent protective cover plate positioned on an upper side of the touch screen.

10. The handheld Bluetooth photographing screen according to claim 9, wherein an embedding slot matching the liquid crystal display screen is defined in the inner frame, the handheld Bluetooth photographing screen further comprises a connecting through hole defined in the inner frame, and the liquid crystal display screen is electrically connected to the control circuit board through the connecting through hole.

11. The handheld Bluetooth photographing screen according to claim 7, wherein a magnetic attraction block is provided on a back surface of the main body shell, and the main body is attached to a back surface of the external mobile terminal through the magnetic attraction block.

12. The handheld Bluetooth photographing screen according to claim 7, wherein an inner portion of the main body is also provided with a sound emitting device for synchronously emitting sound when a video is played, the sound emitting device is electrically connected to the control circuit board, and a sound emitting hole is defined in a lower portion or a side wall of the main body shell.

13. The handheld Bluetooth photographing screen according to claim 7, wherein the main body is provided with a microphone component, the microphone component is electrically connected to the control circuit board, and microphone holes are defined at a lower portion of the main body shell.

14. The handheld Bluetooth photographing screen according to claim 1, wherein the main body is also provided with an SD card slot, a side edge of the main body is provided with an HDMI interface, and a back surface of the main body is also equipped with a dust cover to prevent dust from entering an inner portion of the main body.

15. The handheld Bluetooth photographing screen according to claim 1, wherein a model of the WiFi module is RTL8188FTV.

16. The handheld Bluetooth photographing screen according to claim 7, wherein the inner frame is connected to the main body shell through a screw; a plurality of screw columns for connection are integrally formed on an inner side of the main body shell; and an outer periphery of the inner frame is provided with through holes corresponding to the screw columns.

17. The handheld Bluetooth photographing screen according to claim 1, wherein a model of a control chip in the control circuit board is DH350D.

18. The handheld Bluetooth photographing screen according to claim 1, wherein a model of the Bluetooth module is nRF52840; a model of the WiFi module is SYN480R; and a model of the control chip in the control circuit board is Snapdragon870.
